(19) United States
(12) Patent Application Publication
(10) Pub. No.: US 2019/0169379 A1
(43) Pub. Date: Jun. 6, 2019

(54) SYSTEM THAT UTILIZES CARBON NANOMATERIAL IN POLYMER MATRIX WITH SPECIFIC FEATURES OF SURFACE TUBE AND SURROUNDING POLYMERIC INTERACTIONS FOR IMPROVED AGGREGATE STABILITY

(71) Applicant: Khaled Abdullah Alhussan, Riyadh (SA)

(72) Inventor: Khaled Abdullah Alhussan, Riyadh (SA)

(21) Appl. No.: 16/208,929

(22) Filed: Dec. 4, 2018

Related U.S. Application Data
(60) Provisional application No. 62/594,357, filed on Dec. 4, 2017.

(51) Int. Cl. C08J 5/04; C08K 3/04; C08K 5/19; C08L 61/06

(52) U.S. Cl. CPC C08J 5/042; C08K 3/041; C08K 5/19; C08K 2201/011; C08J 2361/10; C01B 2202/04; C08L 61/06

(57) ABSTRACT

A method of creating a composite material with aggregate stability of carbon nanotubes includes carrying out submicron emission of Carbon Nanomaterial particles; conducting a dispersion analysis of the carbon nanomaterial particles of water suspension through a particle size laser diffraction analyzer; introducing carbon nanomaterial particles into a binder and mixing; adding resin into a mixture of carbon nanomaterial particles and the binder; applying a finished resin to a glass grid to create a saturated glass grid; drying the saturated glass grid, causing evaporation of binder volatile components; and slicing the glass grid into segments for analysis.

### BACKGROUND

### 1. Field of the Invention

The present invention relates generally to carbon nanotube systems, and more specifically, to a system with aggregate stability of carbon nanotube polymer matrix with specific features of surface tube and surrounding polymeric interactions.

### 2. Description of Related Art

Carbon nanotube systems are well known in the art and are recognized as material with great stiffness and strength, as well as other superior mechanical properties. Carbon nanotubes are currently used in a wide range of industries and include uses such as energy storage, automotive parts, boat hulls, sporting goods, water filters, and electronics. Further, carbon nanotubes are the subject of vast research for uses in medical devise and as building blocks for every day products.

One of the problems commonly associated with carbon nanotube systems is the tendency of the carbon nanotubes and nanofibers to form agglomerates when incorporated into a matrix. This is due to the small size and high energy content of the carbon nanotubes and decreases the efficiency of additive and matrix interactions.

Accordingly, although great strides have been made in the area of carbon nanotube systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified schematic of a system in accordance with the present invention;

FIG. 2 is an oblique view of a multiwall carbon nanotube in accordance with the system of the present invention;

FIG. 3 is a flowchart of a method in accordance with the present invention;

FIG. 4 is a flowchart of the method of treating carbon nanotubes in accordance with the present application;

FIG. 5 is a table of analysis of a composite material created via the system and method of the present invention;

FIG. 6 is a series of graphs demonstrating the particle size distribution associated with carbon nanotube particles of FIG. 1;

FIG. 7 is an SEM image of a dispersion curve of water suspension with carbon nanotubes;

FIG. 8 is a TEM image of a dispersion curve of water suspension with carbon nanotubes; and

FIG. 9 is a graph of the analysis of composite material strength of carbon nanotube particles in formaldehyde resin.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional carbon nanotube systems. Specifically, the present invention provides a means to create composite material with aggregate stability of carbon nanotube polymer matrix for use in a variety of products. In addition, the present invention provides a means to utilize carbon nanomaterial treatment for the improvement of its aggregate stability when introducing into phenolic matrix. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

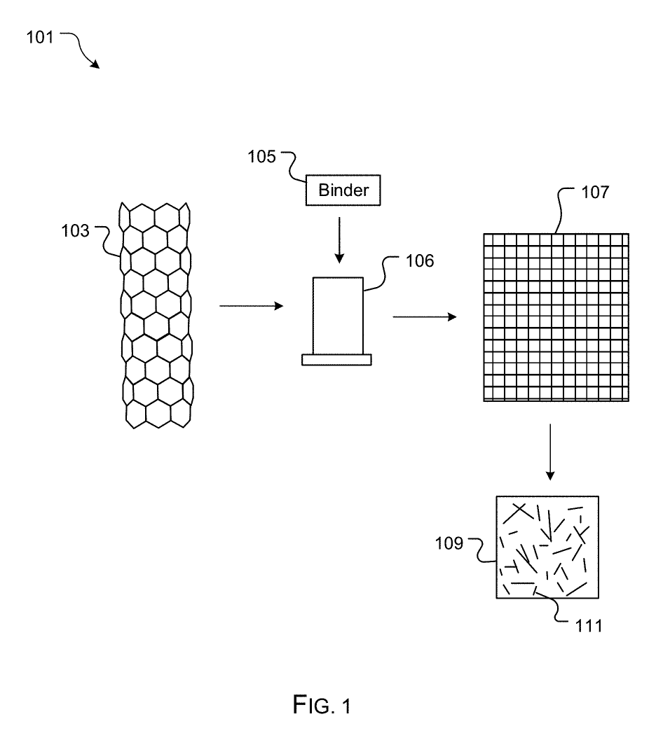

Referring now to the drawings wherein like reference characters identify corresponding or similar elements throughout the several views, FIG. 1 depicts a simplified schematic of a system 101 in accordance with the present application. It will be appreciated that system 101 overcomes one or more of the above-listed problems commonly associated with conventional carbon nanotube systems.

In the contemplated embodiment, system 101 includes carbon nanotube and/or nanofiber particles (CNM) 103. It should be understood that the carbon nanotubes can consist of single, double, or multi-wall nanotubes. It should further be appreciated that carbon nanotubes can be purchased within the industry, or alternatively, can be created. One means of creating carbon nanotubes for use in the present invention consists of using a unit with the application of atmospheric pressure high voltage discharge.

The carbon nanotubes (CNM) are incorporated with a binder 105 via a technique known in the art, such as through the use of a dissolver, to create a resin 106 to be applied to a grid 107 made of glass fabric. After the saturated glass fabric is dried, such as through the use of an oven, the breaking load of the matrix 109 can be analyzed using conventional methods. It should be appreciated that due to the method described herein, the matrix 109 includes the carbon nanotubes 111 having a relatively even distribution, which improves stability and predictability.

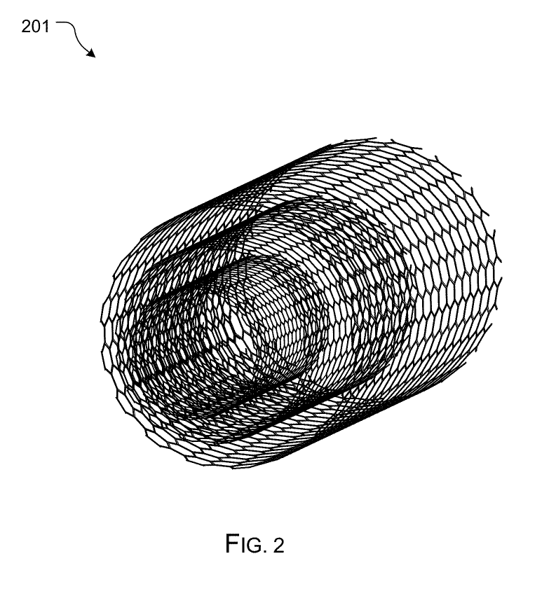

In FIG. 2 an oblique view of a multiwall carbon nanotube 201 (CNM Particles) is shown. It should be appreciated that carbon nanotube 201 can be used in system 101. Carbon Nanotube 201 includes a plurality of rolled walls forming a cylindrical shape. It is understood that these particular CNM particles include unique properties, such as being resistant to chemicals. As described above, conventional uses of carbon nanotubes pose challenges due to their high energy content and small size. The system and method of the present invention provides a means to treat the CNM particles so as to improve its stability, thereby making the CNM particles more usable.

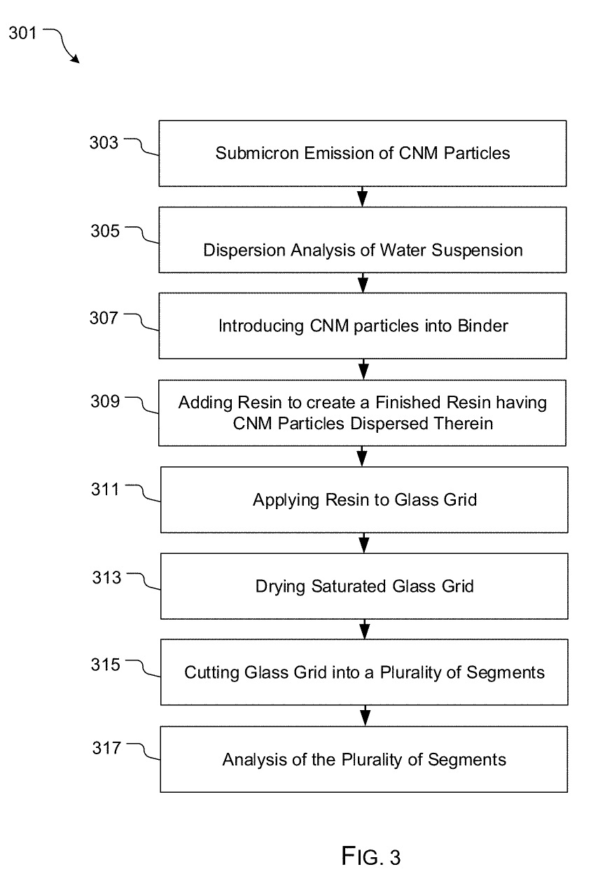

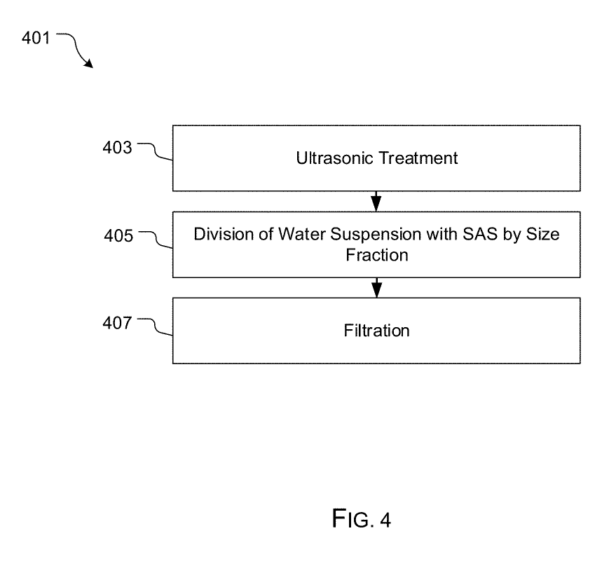

In FIG. 3, a flowchart 301 depicts the method associated with system 101. A plurality of composite test samples are created by first carrying out submicron emission of the CNM particles, as shown with box 303. In the preferred embodiment, this procedure is carried out by specific stages, shown in FIG. 4, flowchart 401. First, the CNM particles receive ultrasonic treatment, as shown with box 403. Then there occurs the division of water suspension with surface-active substances (SAS) by size fraction, as shown with box 405. This is followed by filtration, as shown with box 407. In the present embodiment, SAS was presented by cationic dodecyltrimethylammoniom bromide (DTAB).

Referring back to FIG. 3, flowchart 301, a dispersion analysis of water suspension of the CNM particles is carried out by particle size laser diffraction analyzer Fritsch “analyzette 22”, Nanotec, as shown with box 305. CNM particles are then introduced into the binder and mixed in a dissolver, as shown with box 307. The resin is then mixed into the dissolver by a special miller at about 1400 rpm for 30 minutes, and the finished resin is then applied to the glass grid, as shown with boxes 309, 311. It should be understood that the amount of additive is determinable according to mass.

The saturated glass grid is dried, preferably by an oven technique at a temperature of approximately 100-105 degrees Celcius for 30 minutes, as shown with box 313. It should be understood that this step causes the evaporation of binder volatile components. The dried grid is then cut into a plurality of segments to be analyzed for one or more features, such as breaking load, as shown with boxes 315, 317.

It should be appreciated that one of the unique features believed characteristic of the present application is the method of applying the carbon nanotubes to a glass grid. It should be appreciated that this method has shown to produce a system with aggregate stability of carbon nanotube polymer matrix, which provides for improved predictability of the composite structure. This allows for improved use of carbon nanotubes in composites for uses such as in aircrafts, the carbon nanotubes increasing the strength and stiffness of the composite structure.

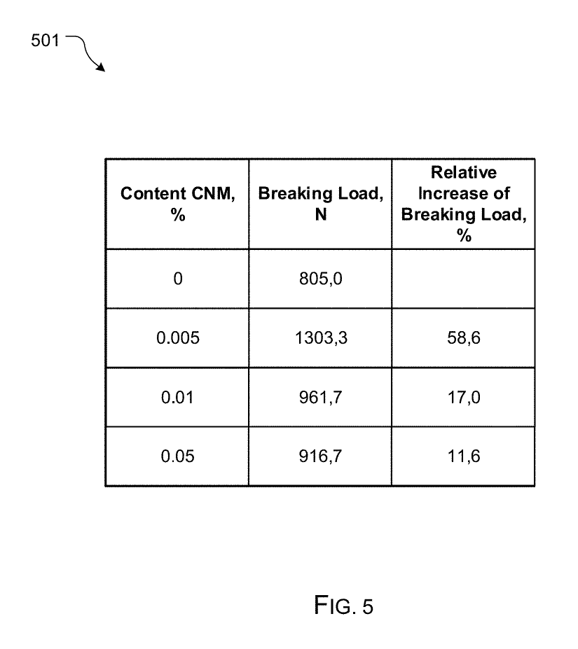

In FIG. 5, a table 501 demonstrates the results of the analysis of the breaking load of a plurality of segments of glass grids saturated by phenolic binder with carbon nanostructure additives of increasing saturation. As shown, the percentage of CNM additive increases from 0% to 0.05%. As further demonstrated, it can be concluded that the introduction of carbon nanomaterial additives in phenolic binder leads to an increase of breaking load, when the carbon nanomaterial in resin is 0.005%.

It should further be understood and appreciated that the quality and physical chemical properties of the initial glass grid, as well as the content of the binder can play a role in the strength (breaking load) of the saturated grid.

Another unique feature believed characteristic of the present application is the utilization of carbon nanomaterial treatment for the improvement of aggregate stability when introducing into phenolic matrix.

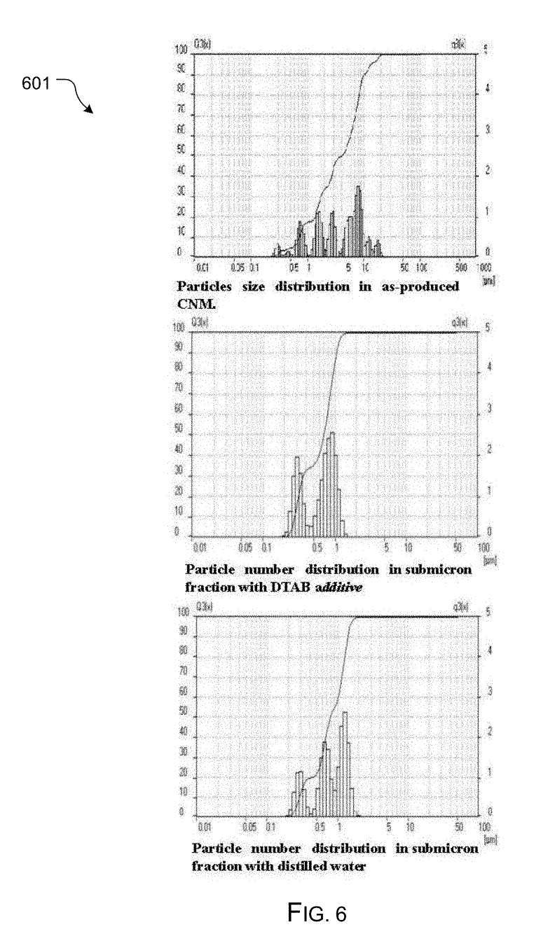

In FIG. 6, a series 601 of graphs demonstrate particle size distribution with regard to the carbon nanomaterial particles in three different settings. As shown in the first graph, particle size distribution in as-produced CNM particles is shown. The second graph demonstrates particle number distribution in submicron fraction with dodecyltrimethylammonium bromide (DTAB) additive. It can be seen from this graph that the CNM particle material with DTAB contains submicron fraction of about 90%. In the last graph of FIG. 3, particle number distribution in submicron fraction with distilled water is shown. It should be appreciated and understood from this analysis that application of cationic SAS DTAB in the process of preliminary treatment is the promising for the improvement of aggregate stability of carbon nanomaterial when introducing into a phenolic matrix.

It should be appreciated that the system and method discussed herein, provides analysis for the creation of a composite material with improved strength. This analysis allows for statistics and analysis to create a composite material with a desired breaking load via altering a percentage of carbon nanotube percentages.

Another unique feature believed characteristic of the present application is the creation of a composite with an increased strength, making the composite suitable for use with its wear resistance in a final product.

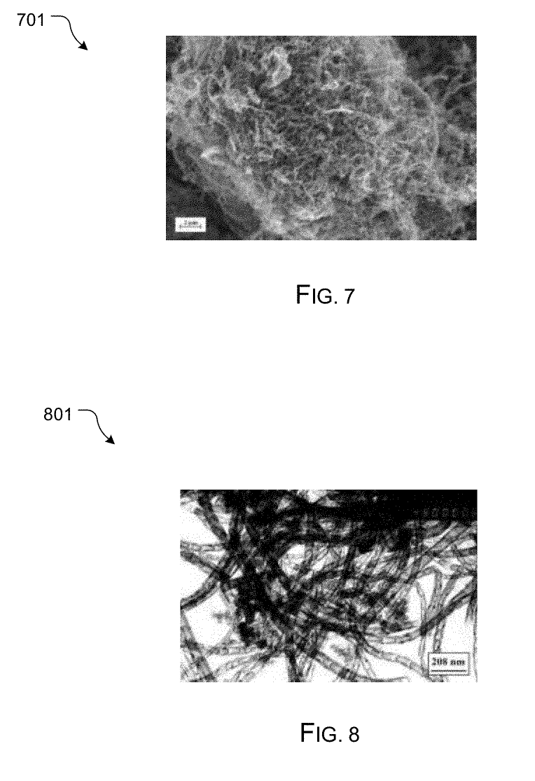

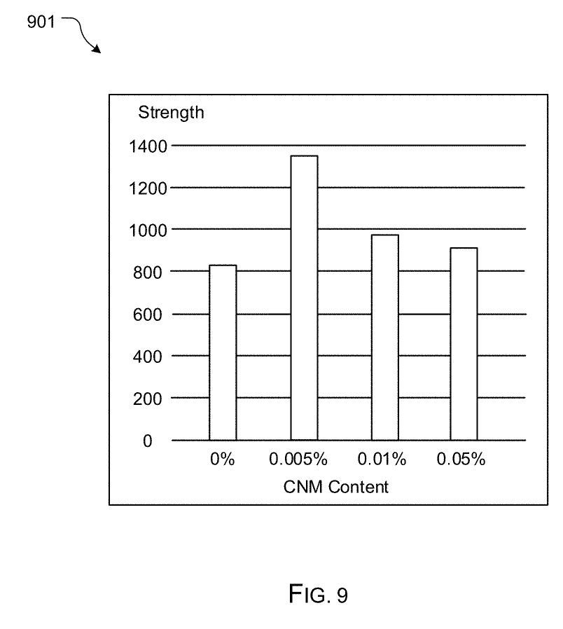

In FIGS. 7 and 8, an SEM image 701 and TEM image 801 show the dispersion curve of water suspensions of CNM with DTAB. It can be seen from image 701 and 801 that material with DTAB contains submicron fraction of about 90%.

In FIG. 9, a graph 901 further demonstrates the dependence of composite material strength on CNM content in formaldehyde resin. As shown, the highest strength was found at the 0.005% of CNM content. It should be appreciated that the system and method discussed herein, provides analysis for the creation of a composite material with improved strength. This analysis allows for statistics and analysis to create a composite material with a desired breaking load via altering a percentage of carbon nanotube percentages.

It should be appreciated that the system and method discussed herein, provides analysis for the creation of a composite material with improved strength. This analysis allows for statistics and analysis to create a composite material with a desired breaking load via altering a percentage of carbon nanotube percentages.

In the present invention, the treated carbon nanotube composite shows improved aggregate stability and provides a means to increase the strength of a glass grid.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A composite material for use in various applications, the composite material comprising:
a resin mixture, having
a phenolic binder; and
a plurality of carbon nanotubes mixed into the phenolic binder;
a glass fabric configured to receive the resin mixture thereon to create a saturated glass grid;
wherein the composite material includes aggregate stability of the plurality of carbon nanotubes; and
wherein the glass grid serves as the composite material to be used in a plurality of structures.

2. The composite material of claim 1, wherein the resin mixture is a formaldehyde resin.

3. The composite material of claim 1, wherein the plurality of carbon nanotubes are single-walled carbon nanotubes.

4. The composite material of claim 1, wherein the plurality of carbon nanotubes are double-walled carbon nanotubes.

5. The composite material of claim 1, wherein the plurality of carbon nanotubes are treated through submicron emission.

6. The composite material of claim 5, wherein the plurality of carbon nanotubes are treated with dodecyltrimethylammoniom bromide (DTAB).

7. A system for utilizing nanomaterial treatment for the improvement of its aggregate stability when introducing into phenolic matrix, the system comprising:
a plurality of carbon nanotubes treated through submicron emission of the plurality of carbon nanotubes;
a surface active substance configured to be added to the plurality of carbon nanotubes to lower the surface tension;
a laser diffraction analyzer configured to analyze dispersion of water suspension of the plurality of carbon nanotube particles; and
a plurality of graphs generated via the laser diffraction;
wherein the plurality of graphs relate to an effect of a treatment of the plurality of carbon nanotubes by the surface active substance.

8. The system of claim 7, wherein the plurality of carbon nanotubes are double walled.

9. The system of claim 7, wherein the surface active substance is dodecyltrimethylammoniom bromide (DRAB).

10. A method of creating a composite material with aggregate stability of carbon nanotubes, the method comprising:
carrying out submicron emission of a plurality of carbon nanotubes;
conducting a dispersion analysis of the plurality of carbon nanotubes of water suspension through a particle size laser diffraction analyzer;
introducing the plurality of carbon nanotubes into a binder and mixing;
adding resin into a mixture of the carbon nanotubes and the binder;
applying a finished resin to a glass grid to create a saturated glass grid;
drying the saturated glass grid, causing evaporation of binder volatile components; and
slicing the glass grid into a plurality of segments for analysis.

11. The method of claim 10, wherein the submicron emission of carbon nanomaterial particles further comprises:
providing an ultrasonic treatment of the plurality of carbon nanotubes;
adding a surface active substance to the plurality of carbon nanotubes, thereby lowering the surface tension to create treated carbon nanotubes; and
filtering the treated carbon nanotubes; and
conducting dispersion analysis of the treated carbon nanotubes;
wherein a plurality of charts are created for analysis.

12. The method of claim 11, wherein the surface active substance is dodecyltrimethylammoniom bromide.

13. The method of claim 10, further comprising:
mixing the plurality of carbon nanotubes and binder via a dissolver; and
mixing the resin into the mixture of carbon nanomaterial particles and the binder via a miller.

14. The method of claim 10, wherein the drying is conducted via an oven.

14. The method of claim 10, further comprising:
analyzing the plurality of segments of glass gird for breaking load.

15. The method of claim 10, further comprising:
determining a percentage of carbon nanomaterial particles to be used to reach an optimum breaking load.
